(19) United States
(12) Patent Application Publication
(10) Pub. No.: US 2002/0197014 A1
(43) Pub. Date: Dec. 26, 2002

(54) Manufacture of polarization maintaining optical fiber coupler

(75) Inventor: Yellapu Anjan, Scottsdale, AZ (US)

Correspondence Address: Donald J. Lenkszus, DONALD J. LENKSZUS, P.C., P.O. BOX 3064, Carefree, AZ, 85377, US

(73) Assignee: MICRO PHOTONIX INTEGRATION CORPORATION

(21) Appl. No.: 09/887,889

(22) Filed: Jun. 22, 2001

(51) Int. Cl. G02B 6/26

(52) U.S. Cl. 385/43

(57) ABSTRACT

In a method of manufacturing a polarization maintaining optical coupler, protective jackets of the optical fibers are tapered adjacent the fused portions. In one embodiment of the method a fusing heat source travels repeatedly over a fixed predetermined distance. The fused portion is surrounded by air.

### CROSS REFERENCE TO RELATED APPLICATIONS

This application is a continuation of and claims the benefit of prior U.S. patent application Ser. No. (not yet assigned) filed on Jun. 19, 2001 and assigned to a common assignee.

### FIELD OF THE INVENTION

This invention pertains to optical fiber couplers, in general, and to polarization maintaining optical fiber couplers, in particular.

### BACKGROUND OF THE INVENTION

Optical fiber couplers are used for splitting optical power and for wavelength division multiplexing. Polarization maintaining (PM) couplers also maintain the polarization of light launched into the coupler input. PM couplers are utilized in fiber optical communication products and in fiber optic sensor products such as fiber optic gyroscopes.

Single mode optical fiber carries two orthogonal polarized modes with almost identical velocities. As a result, cross coupling of the two polarization modes occurs whenever temperature changes or mechanical vibrations take place. The polarization cross coupling causes polarization mode dispersion (PMD). PMD, in turn, leads to broadening of optical pulses.

Polarization maintaining fiber is fabricated by introducing stress applying members during manufacture of the fiber. The stress applying parts create a birefringence as a result of the refractive index difference between the two polarizations. This birefringence makes the two polarization modes propagate at different speeds, slow and fast, which is the reason that there are two orthogonal principal axes corresponding to the two speeds. There are three commonly used types of PM fiber based on the geometries of the stress applying members: PANDA bow tie and elliptically stressed. PANDA is the most commonly used telecom PM fiber. PANDA fiber includes a protective jacket over the fiber and the fiber comprises two stress rods disposed on either side of the optical core.

Optical fiber PM couplers are either of a mechanical lapped and polished type or a fused taper type. In the fabrication of both types, alignment of the polarization principal axis is essential. The mechanical lapped and polished type coupler is fabricated by embedding an unjacketed fiber in a grooved quartz block and mechanically lapping and polishing the block until the fiber core is reached. Two such blocks are bonded together to form a coupler. Couplers of this type demonstrate low loss and high polarization extinction ratio performance. However, the performance is achieved only over a limited temperature range. Additionally, the fabrication of mechanically lapped and polished type couplers is a labor intensive and time consuming process with the result that production costs are expensive.

The fabrication of fused taper type couplers involves aligning the fibers; and fusing and tapering the fibers until a desired coupling of optical power is realized. The fusion and tapering process produces a single piece of glass in the coupling region resulting in a more stable type of coupler than the mechanically lapped and polished type.

### SUMMARY OF THE INVENTION

In accordance with the principles of the invention, a method of manufacturing an optical coupler includes the step of orienting first and second polarization maintaining optical fibers to a first predetermined orientation. A first portion of the first and second optical fibers are placed in a side-by-side relationship. In a fusing step the first portion of the first and second optical fibers are heated with heat from a heat source to produce a fused portion. The fused portion is subjected to a tapering to produce a predetermined taper over the fused portion. During the fusing and tapering steps the heat source is moved repeatedly over a predetermined fixed distance.

In a preferred embodiment of the invention the first and second polarization maintaining fibers are PANDA fiber. The first and second optical fibers each have first and second polarization modes corresponding to first and second orthogonal principal axes and the first predetermined orientation comprises one of the first or second polarization modes.

Further in accordance with one aspect of the invention, each of orienting step includes illuminating a respective one fiber with a laser source while rotating the fiber around its respective longitudinal axis. The interference pattern produced in the fiber is monitored. Rotation is ceased when the interference pattern corresponds to a predetermined pattern.

Yet further in accordance with the invention the first and second optical fibers are supported on a substrate. A dielectric gel is disposed on the first and second optical fibers and the substrate proximate each end of the fused portion.

In one method in accordance with the invention each of optical fiber comprises a jacket; and the method includes removing the jacket from the first and second optical fibers in a region corresponding to the first portion. The first optical fiber jacket is bonded to the second optical fiber jacket adjacent each end of said first portion. The method includes tapering the first optical fiber jacket adjacent each end of the first portion to produce first and second tapered portions; and tapering the second optical fiber jacket adjacent each end of the first portion to produce first and second tapered portions. In accordance with certain aspects of the invention steps are included of bonding the first optical fiber first tapered portion to the second optical fiber first portion; and bonding the first optical fiber second tapered portion to the second optical fiber second tapered portion.

In accordance with another aspect of the invention steps are included of mounting and bonding the first and second optical fibers to a substrate; providing dielectric gel on the substrate and on each of said first and second optical fibers in regions proximate the ends of the first portion; assembling the substrate and with the first and second optical fibers in a housing; and providing air around the first portion in the coupler.

### BRIEF DESCRIPTION OF THE DRAWING

The invention will be better understood from a reading of the following detailed description in conjunction with the drawing figures in which like reference numerals are used to designate like elements, and in which:

FIG. 1 shows an optical coupler in accordance with the principles of the invention;

FIG. 2 shows the optical coupler of FIG. 1 in longitudinal cross section;

FIG. 3 is a cross-section of the optical coupler of FIG. 2 taken at lines 3-3;

FIG. 4 is a cross-section of the optical coupler of FIG. 2 taken at lines 4-4;

FIG. 5 is a cross-section of the optical coupler of FIG. 2 taken at lines 5-5;

FIG. 6 is a cross-section of the optical coupler of FIG. 2 taken at lines 6-6;

FIG. 7 illustrates a fiber alignment station arrangement for manufacturing the coupler of FIG. 1;

FIG. 8 illustrates a coupler draw station utilized to form the coupler of FIG. 1;

FIG. 9 illustrates two optical fibers utilized to construct the coupler of FIG. 1;

FIG. 10 illustrates the two fibers of FIG. 9 fused together in accordance with the invention; and

FIGS. 11, 12, and 13 are cross-section drawings taken at lines A-A of FIG. 10.

### DETAILED DESCRIPTION

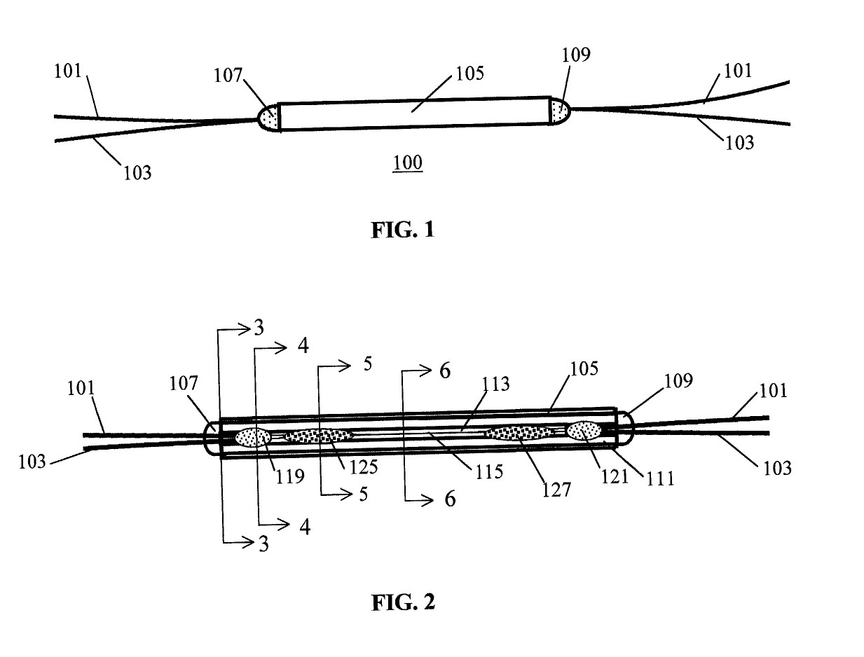

Turning now to FIG. 1, a small sized polarization maintaining optical fiber coupler 100 is shown. Coupler 100 utilizes standard 125 micron cladding diameter polarization maintaining optical fiber 101, 103. The specific fiber utilized in the illustrative embodiment of the invention is PANDA fiber. Coupler 100 includes a stainless steel tubular package 105 that is sealed at each end 107, 109 with epoxy. As more clearly seen in the longitudinal cross-section of FIG. 2, optical fibers 101, 103 are disposed in a channel 113 formed in a substrate 111. In the illustrative embodiment of the invention, substrate 111 is a fused silica substrate.

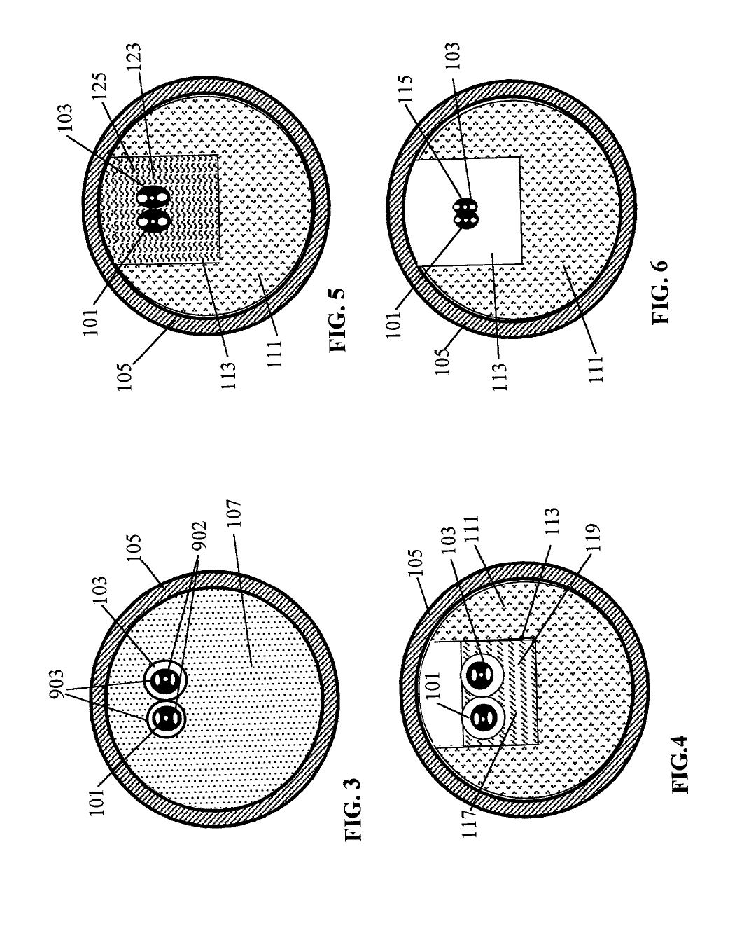

As will be explained in greater detail hereinafter, the two optical fibers 101, 103 each have the plastic jacket cladding removed over a length that in the illustrative embodiment ranges from 20 to 24 mm. Fiber 101 is aligned vertically to either the slow or fast principle polarization axis. Fiber 103 is aligned identically to fiber 101. The cladding of each fiber 101, 103 that contacts the other fiber 103, 101 is shaved to produce a taper to bring the fibers 101, 103 closer to each other and the fibers 101, 103 are epoxy bonded to each other UV curable epoxy. The aligned fibers are fused and tapered to produce resulting coupler section 115. The resulting coupler is disposed into channel 113 of substrate 111. Fibers 101, 103 and substrate 111 are encapsulated into stainless steel tube 105 with epoxy end capping 107, 109 as shown in FIG. 3. As shown in the cross-section of FIG. 4, fibers 101, 103 are bonded into channel 113 with heat curable epoxy 117 in regions 119, 121 proximate end caps 107, 109. To minimize vibration effects, a dielectric gel 123 is disposed in regions 125, 127 of channel 113 as shown in the cross-section of FIG. 5. Regions 125, 127 are proximate the ends of the coupling region 115 of optical fibers 101, 103. In coupling region 115, the bare, fused fiber is surrounded by air 133 as shown in FIG. 6.

The length of the packaged coupler is 32 to 34 mm with a diameter of 3 mm. Typical losses are less than 0.5 dB and polarization extinction rations at the two output fibers is better than 20 dB.

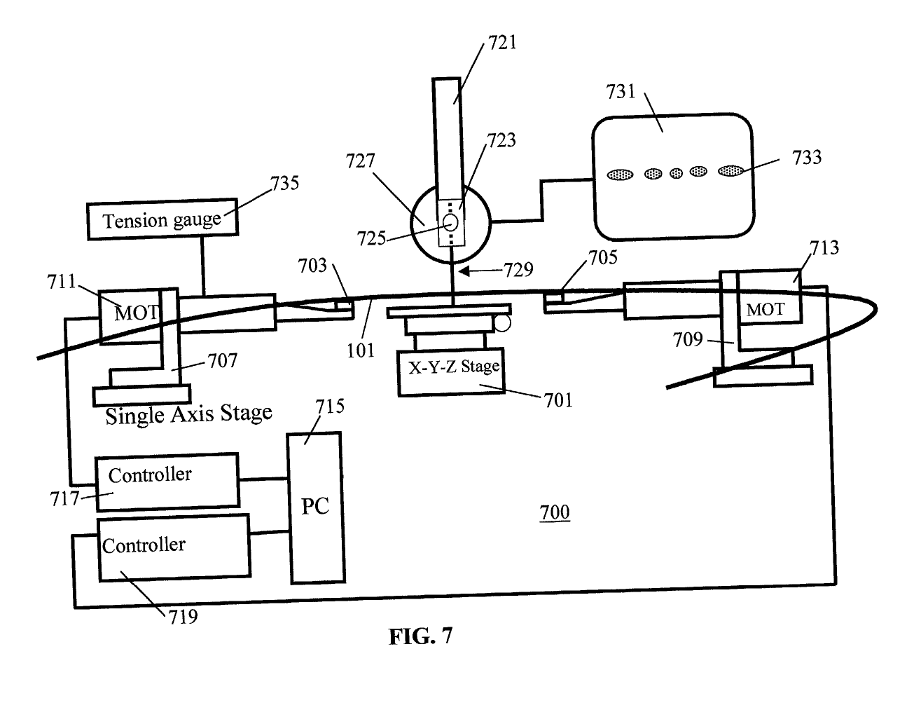

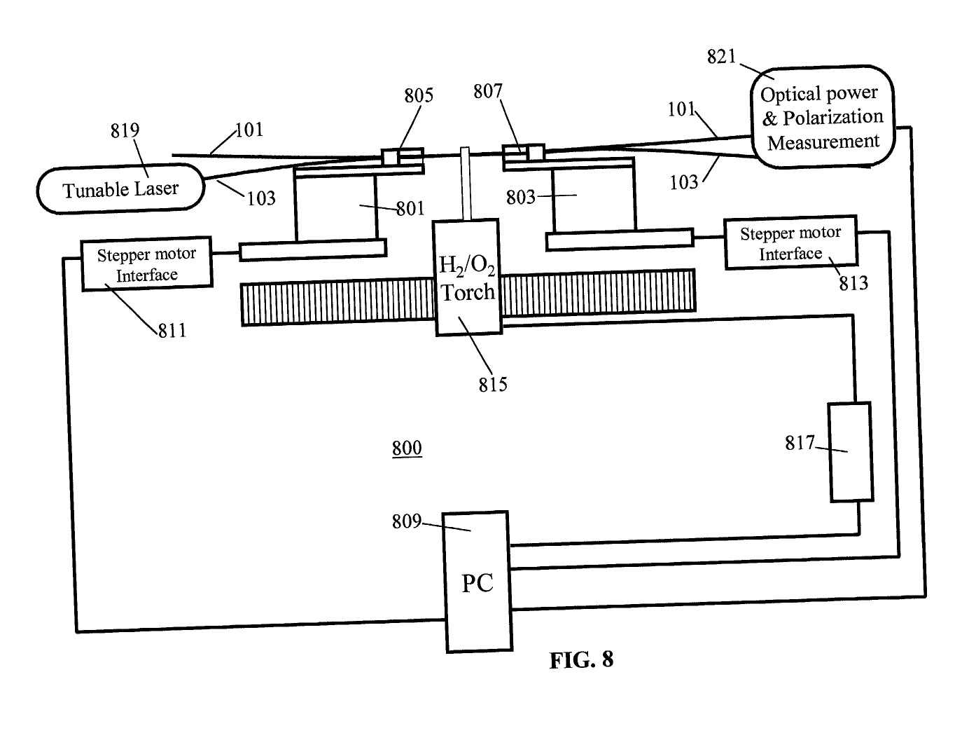

Optical fiber coupler 100 is manufactured utilizing an alignment station 700 shown in FIG. 7 and a draw station 800 shown in FIG. 8.

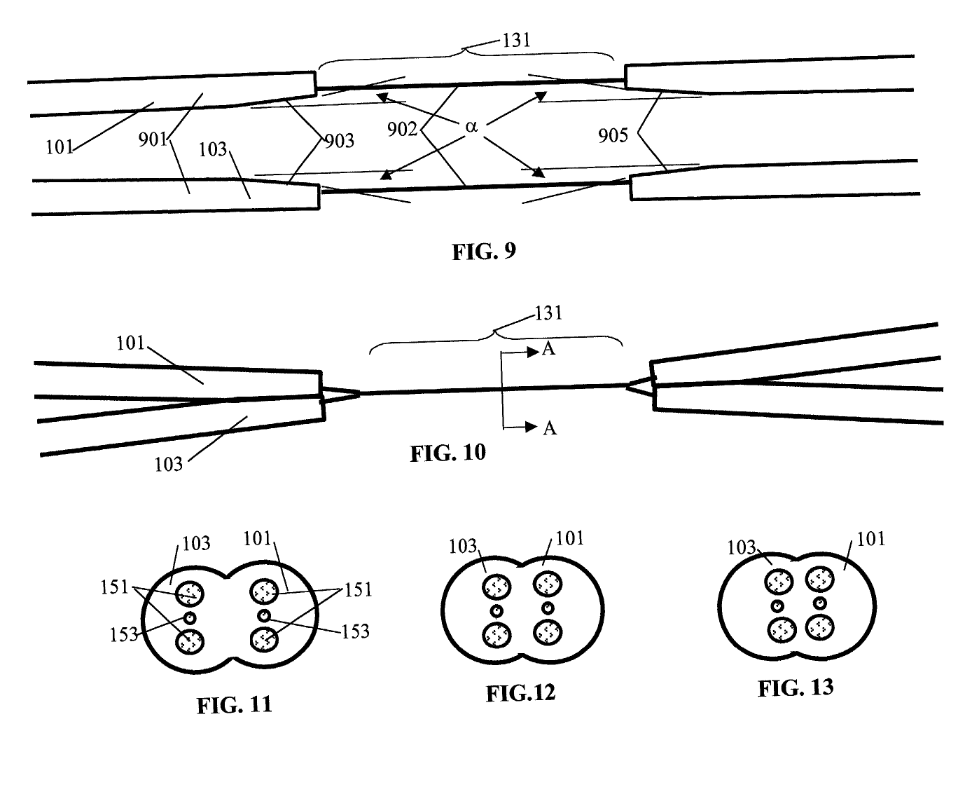

Fiber alignment station 700 is utilized to vertically align optical fibers so as to identically align fibers according to a selected polarization axis. As more clearly shown in FIG. 9, each PANDA fiber 101, 103 includes a protective plastic jacket 901 surrounding its fiber 902. Prior to subjecting each fiber to alignment, the protective plastic jacket 901 is removed over a region 131 in which the optical fiber 101 will be fused to a second optical fiber 103. After removal of protective plastic jacket or cladding 901 in region 131, the optical fiber 902 is exposed.

Turning back to FIG. 7, the optical fiber 101 is then fed into the alignment station 700. At the alignment station, the optical fiber 101 is positioned on an x-y-z stage 701. Optical fiber 101 is captured by fiber clamps 703, 705 each respectively coupled to single axis stages 707, 709 having stepper motors 711, 713, respectively. The optical fiber is supported with a predetermined tension, as monitored by tension gauge 735, between the two stepper motors 711, 713 and supported on x-y-z stage 701. A computer 715 is coupled to stepper motor controllers 717, 719 and is used to axially rotate optical fiber 101, 103 to a predetermined position. The predetermined position is determined by utilizing a helium neon laser to illuminate the fiber 101, 103. The laser light passes through a reflector 723 having an aperture 725 formed therein for passage of the laser beam 729. Reflector 723 is disposed at a 45° angle to laser beam 729 and disposed to reflect the image from optical fiber 101, 103 to a CCD camera 727. CCD camera 727 is coupled to a monitor 731.

Computer 715 is utilized to cause both stepper motors 711, 713 to rotate optical fiber 101, 103 while the fiber is illuminated by laser beam 729. The illumination of fiber 101, 103 by laser beam 729 causes a visible interference or “dot” pattern to occur in the illuminated fiber 101, 103. The fiber is rotated until the predetermined dot pattern 733 appears on monitor 731. At that time the optical fiber 101, 103 is retained in position. As shown if FIG. 9, the plastic jacket or cladding 901 immediately adjacent the bare fiber portion 131 of the optical fiber 101, 103 held in position is shaved to produce a flat surface 903, 905 tapered at a predetermined angle a to the longitudinal axis of the optical fiber. By providing tapered surfaces 903, 905 at an angle “a”, the bare portions 131 of optical fibers 101, 103 may be placed in side-by-side relationship without producing significant stress on the optical fibers 101, 103. An ultraviolet curable epoxy is disposed on the shaved surfaces 903, 905 and the optical fibers 101, 103 are placed side by side with surfaces 903, 905 on each of the two fibers 101, 103 mating against each other and the bare optical fiber cores of fibers 101, 103 being in contact with each other.

The fiber assembly of optical fibers 101, 103 is then placed in draw station 800 shown in FIG. 8. Draw station 800 is used to fuse and taper optical fibers 101, 103 using predetermined fabrication parameters in menu-driven computer 809 that controls operation of the draw station. Draw station 800 includes stepper motors 801, 803 that have clamps 805, 807 that capture and support optical fibers 101, 103. Computer 809 via stepper motor interfaces 811, 813 controls each stepper motor. Draw station 800 also includes an H₂/O₂ micro gas torch 815 that is positionally controlled by computer 809 via interface 817. Details of the gas generator that supplies the gases to torch 815 are not shown in the drawing figures for clarity. A tunable laser 819 is coupled to one end of fiber 103. Optical power and polarization measurement apparatus 821 is coupled to fiber 101 and 103. With this arrangement, the amount of coupling between fiber 101 and fiber 103 is precisely determined during the manufacture of the coupler. The amount of coupling between fibers 101, 103 is determined by the amount of taper of the fused fibers 101, 103.

FIGS. 11, 12, 13 illustrate three different types of fusion of fibers 101, 103 in cross-sectional FIG. 11 illustrates the case where there is light fusion of the two fibers 101, 103. FIG. 12 illustrates the instance with medium fusion and FIG. 13 illustrates strong fusion. As shown in FIG. 11, PANDA fibers 101, 103 each include stress rods 151 and an optical core 153.

Draw station 800 operates by having torch 815 travel at a constant velocity back and forth over the entirety of the coupling region of fibers 101, 103 while stepper motors 801, 803 draw the heated fibers such that fusion occurs along the entirely of the travel range of torch 815. Tunable laser 821 couples light into fiber 103 and apparatus 821 monitors the light output from fibers 101, 103 until the desired couple power between fibers 101, 103 is obtained. Torch 821 is then turned of. The resulting fused optical fibers 101, 103 are then placed in a channel 113 of a fused silicon substrate 111 as shown in FIG. 2. Fibers 101, 103 are attached to substrate 111 with heat curable epoxy 119, 121 while maintaining the fibers 101, 103 straight. The epoxy is cured at 120° Centigrade for 10 minutes. The bare fibers are covered with a dielectric gel 125, 127 while leaving the coupling region of the fibers 101, 103 exposed to air with no surrounding material immediately proximate the fibers. The substrate assembly is cured in an oven at 50° Centigrade for a predetermined time. The substrate 111 is then inserted into a stainless steel tube 105 with three dots of epoxy at the bottom of the substrate 111. The ends of the assembly are sealed with epoxy 107.

As will be appreciated by those skilled in the art, various modifications can be made to the embodiments shown in the various drawing figures and described above without departing from the spirit or scope of the invention. In addition, reference is made to various directions in the above description. It will be understood that the directional orientations are with reference to the particular drawing layout and are not intended to be limiting or restrictive. It is not intended that the invention be limited to the illustrative embodiments shown and described. It is intended that the invention be limited in scope only by the claims appended hereto.

What is claimed is:

1. A method of manufacturing an optical coupler, comprising:
orienting a polarization maintaining first optical fiber to a first predetermined orientation;
orienting a polarization maintaining second optical fiber to said first predetermined orientation;
placing a first portion of said first and second optical fibers in a side-by-side relationship;
fusing said first portion of said first and second optical fibers with heat from a heat source to produce a fused portion;
tapering said fused portion to produce a predetermined taper over said fused portion; and
moving said heat source repeatedly over a predetermined fixed distance during said fusing and tapering steps.

2. A method in accordance with claim 1, wherein:
said first polarization maintaining fiber is PANDA fiber; and
said second polarization maintaining fiber is PANDA fiber.

3. A method in accordance with claim 1, wherein:
said first and second optical fibers each have first and second polarization modes corresponding to first and second orthogonal principal axes; and wherein
said first predetermined orientation comprises one of said first or second polarization modes.

4. A method in accordance with claim 1, wherein:
each of said orienting steps comprises:
illuminating a respective one fiber of said first or second optical fibers with a laser source;
rotating said respective one fiber around its respective longitudinal axis;
monitoring the interference pattern produced in said respective one fiber; and
ceasing said rotating when said interference pattern corresponds to a predetermined pattern.

5. A method in accordance with claim 1, comprising:
supporting said first and second optical fibers on a substrate.

6. A method in accordance with claim 5, comprising:
encapsulating said substrate and said first and second optical fibers in a housing.

7. A method in accordance with claim 5, comprising:
disposing a dielectric gel on said first and second optical fibers and said substrate proximate each end of said fused portion.

8. A method in accordance with claim 5, wherein:
said substrate comprises fused silicon.

9. A method in accordance with claim 1, wherein:
each of said first and second optical fibers comprises a jacket; and
said method comprises:
removing said first optical fiber jacket in a region corresponding to said first portion; and
removing said second optical fiber jacket in a region corresponding to said first portion.

10. A method in accordance with claim 9, comprising:
bonding said first optical fiber jacket to said second optical fiber jacket adjacent each end of said first portion.

11. A method in accordance with claim 9, comprising:
tapering said first optical fiber jacket adjacent each end of said first portion to produce first and second tapered portions.

12. A method in accordance with claim 11, comprising:
tapering said second optical fiber jacket adjacent each end of said first portion to produce first and second tapered portions.

13. A method in accordance with claim 12, comprising:
bonding said first optical fiber first tapered portion to said second optical fiber first portion; and
bonding said first optical fiber second tapered portion to said second optical fiber second tapered portion.

14. A method in accordance with claim 13, comprising:
selecting PANDA fiber for said first and second optical fibers.

15. A method of manufacturing an optical coupler from first and second optical fibers each comprising an optical fiber and a jacket, said method comprising:
removing a portion of said first optical fiber jacket around a first portion of said first optical fiber;
removing a portion of said second optical fiber jacket around a first portion of said second optical fiber;
tapering said first optical fiber jacket adjacent to each end of said first optical fiber first portion to produce first and second tapered jacket portions;
tapering said second optical fiber jacket adjacent to each end of said second optical fiber first portion to produce first and second tapered jacket portions;
placing said first portions of said first and second optical fibers in a side-by-side relation ship;
bonding said first jacket first tapered portion to said second jacket first tapered portion and said first jacket second tapered portion to said second jacket tapered portion;
fusing said first portions of said first and second optical fibers with heat from a heat source to produce a fused portion; and
tapering said fused portion to produce a predetermined taper over said fused portion.

16. A method in accordance with claim 15, comprising:
orienting said first optical fiber to a first predetermined orientation; and
orienting said second optical fiber to said first predetermined orientation.

17. A method in accordance with claim 15, comprising:
selecting polarization maintaining fiber for said first and second optical fibers.

18. A method in accordance with claim 17, comprising:
selecting PANDA fiber for said first and second optical fibers.

19. A method of manufacturing a fiber optic coupler comprising first and second optical fibers, comprising:
fusing a portion of said first and second optical fibers into a fused portion;
mounting said first and second optical fibers onto a substrate, said substrate having first and second regions extending beyond said portion at both ends of said portion;
bonding said first and second optical fibers to said substrate in said first and second regions;
providing dielectric gel on said substrate and on each of said first and second optical fibers in regions proximate said ends of said portion;
mounting said substrate and said first and second optical fibers in a housing; and
providing air around said portion in said coupler.

20. A method in accordance with claim 19, comprising:
selecting polarization maintaining fiber for said first and second optical fibers.
